(19) United States
(12) Patent Application Publication
(10) Pub. No.: US 2025/0198766 A1
(43) Pub. Date: Jun. 19, 2025

(54) METHOD, APPARATUS, AND SYSTEM FOR MEASURING ERROR IN RELATIVE POSITION DATA FROM A SENSOR

(71) Applicant: HERE Global B.V., Eindhoven (NL)

(72) Inventors: Landis HUFFMAN, Chicago, IL (US); Dennis Scott WILLIAMSON, Wheaton, IL (US)

(21) Appl. No.: 18/543,740

(22) Filed: Dec. 18, 2023

(51) Int. Cl. G01C 21/30

(52) U.S. Cl. CPC G01C 21/30

(57) ABSTRACT

An approach is provided for measuring error in relative position data from a sensor. The approach, for instance, includes determining a pair of position measurements of a point feature. Each of the position measurements is computed from a global position measurement made using a first sensor and a relative position measurement made using a second sensor, and the position measurements of the pair are made within a time threshold or a distance threshold. The approach also involves determining a difference between the first position measurement and the second position measurement. The approach further involves determining an error of the relative position measurement based on the difference. The approach further involves providing the error as an output to indicate a measurement error of the second sensor used to measure the relative position measurement.

### BACKGROUND

Mapping service providers often use a large number of data sources to create their maps, each with differing levels of quality and accuracy. In particular, many of these data sources include measurements of road objects (e.g., observables such as signs, lane markings, etc.) captured during drives in road network by vehicles. However, the measurement of these observables often involve different sensors that may combine fixed and relative measurements into one final position measurement for a respective observable. As a result, there are significant technical challenges in determining how much error each component measurement (e.g., fixed and relative measurements) contributes to the final position measurement, particularly when working with large scale maps.

### SOME EXAMPLE EMBODIMENTS

Therefore, there is a need for an approach for measuring error in relative position data from a sensor.

According to one embodiment, a method comprises determining a pair of position measurements (e.g., the position measurements are of a point feature). Each of the position measurements is computed from a global position measurement made using a first sensor and a relative position measurement made using a second sensor, and the position measurements of the pair are made within a time threshold or a distance threshold. The method also comprises determining a difference between the first position measurement and the second position measurement. The method further comprises determining an error of the relative position measurement based on the difference, and providing the error as an output (e.g., the output can be used to indicate a measurement error of the second sensor used to determine the relative position measurement).

According to another embodiment, an apparatus comprises at least one processor, and at least one memory including computer program code for one or more computer programs, the at least one memory and the computer program code configured to, with the at least one processor, cause, at least in part, the apparatus to determine a pair of position measurements (e.g., the position measurements are of a point feature). Each of the position measurements is computed from a global position measurement made using a first sensor and a relative position measurement made using a second sensor, and the position measurements of the pair are made within a time threshold or a distance threshold. The apparatus is also caused to determine a difference between the first position measurement and the second position measurement. The apparatus is further caused to determine an error of the relative position measurement based on the difference, and provide the error as an output (e.g., the output can be used to indicate a measurement error of the second sensor used to determine the relative position measurement).

According to another embodiment, a non-transitory computer-readable storage medium carries one or more sequences of one or more instructions which, when executed by one or more processors, cause, at least in part, an apparatus to determine a pair of position measurements (e.g., the position measurements are of a point feature). Each of the position measurements is computed from a global position measurement made using a first sensor and a relative position measurement made using a second sensor, and the position measurements of the pair are made within a time threshold or a distance threshold. The apparatus is also caused to determine a difference between the first position measurement and the second position measurement. The apparatus is further caused to determine an error of the relative position measurement based on the difference, and provide the error as an output (e.g., the output can be used to indicate a measurement error of the second sensor used to determine the relative position measurement).

According to another embodiment, an apparatus comprises means for determining a pair of position measurements (e.g., the position measurements are of a point feature). Each of the position measurements is computed from a global position measurement made using a first sensor and a relative position measurement made using a second sensor, and the position measurements of the pair are made within a time threshold or a distance threshold. The apparatus also comprises means for determining a difference between the first position measurement and the second position measurement. The apparatus further comprises means for determining an error of the relative position measurement based on the difference, and means for providing the error as an output (e.g., the output can be used to indicate a measurement error of the second sensor used to determine the relative position measurement).

According to one embodiment, a method comprises determining a pair of position measurements. Each of the position measurements is computed from a global position measurement of a vehicle or a device and a relative position measurement from the vehicle or the device, and the position measurements of the pair are made within a time threshold or a distance threshold. The method also comprises determining a difference between the first position measurement and the second position measurement. The method further comprises determining an error of the relative position measurement based on the difference. The method further comprises providing the error as an output.

According to another embodiment, an apparatus comprises at least one processor, and at least one memory including computer program code for one or more computer programs, the at least one memory and the computer program code configured to, with the at least one processor, cause, at least in part, the apparatus to determine a pair of position measurements. Each of the position measurements is computed from a global position measurement of a vehicle or a device and a relative position measurement from the vehicle or the device, and the position measurements of the pair are made within a time threshold or a distance threshold. The apparatus is also caused to determine a difference between the first position measurement and the second position measurement. The apparatus is further caused to determine an error of the relative position measurement based on the difference. The apparatus is further caused to provide the error as an output.

According to another embodiment, a non-transitory computer-readable storage medium carries one or more sequences of one or more instructions which, when executed by one or more processors, cause, at least in part, an apparatus to determine a pair of position measurements. Each of the position measurements is computed from a global position measurement of a vehicle or a device and a relative position measurement from the vehicle or the device, and the position measurements of the pair are made within a time threshold or a distance threshold. The apparatus is also caused to determine a difference between the first position measurement and the second position measurement. The apparatus is further caused to determine an error of the relative position measurement based on the difference. The apparatus is further caused to provide the error as an output.

According to another embodiment, an apparatus comprises means for determining a pair of position measurements. Each of the position measurements is computed from a global position measurement of a vehicle or a device and a relative position measurement from the vehicle or the device, and the position measurements of the pair are made within a time threshold or a distance threshold. The apparatus also comprises means for determining a difference between the first position measurement and the second position measurement. The apparatus further comprises means for determining an error of the relative position measurement based on the difference. The apparatus further comprises means for providing the error as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of measuring error in relative position data from a sensor, according to one embodiment;

FIG. 2A is a diagram illustrating a relative position measurement, according to one example embodiment;

FIG. 2B is a diagram illustrating positioning error drift over time for a satellite-based positioning system, according to one example embodiment;

FIG. 3 is a diagram illustrating real-time data pipeline for measuring error in relative position data from a sensor, according to one embodiment;

FIG. 4 is a diagram of the components of a mapping platform, according to one example embodiment;

FIG. 5 is a flowchart of a process for measuring error in relative position data from a sensor, according to one example embodiment;

FIG. 6 is a diagram of an example set of relative positioning measurements, according to one example embodiment;

FIG. 7 is a diagram of an example user interface for evaluating data sources based on measuring error in relative position data from a sensor, according to one example embodiment;

FIG. 8 is a diagram of an example user interface for real-time use of measuring error in relative position data from a sensor, according to one example embodiment;

FIG. 9 is a diagram of a geographic database, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal that can be used to implement an embodiment of the invention.

### DESCRIPTION OF SOME EMBODIMENTS

Examples of a method, apparatus, and computer program for measuring error in relative position data from a sensor are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

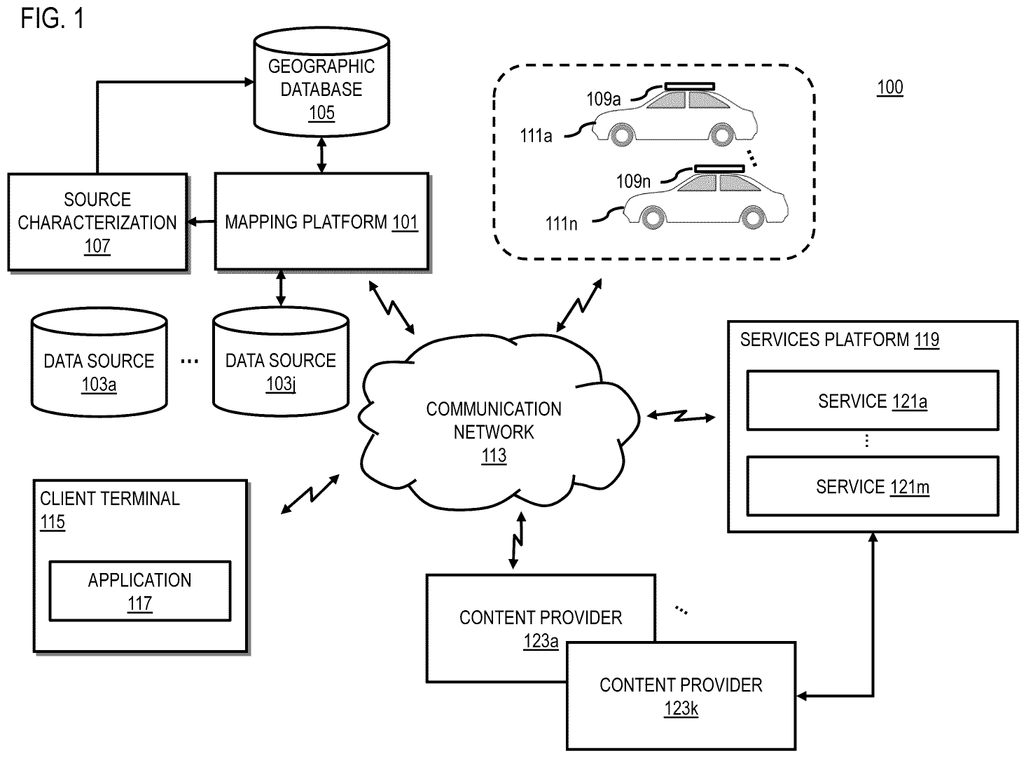

FIG. 1 is a diagram of a system 100 capable of measuring error in relative position data from a sensor, according to one embodiment. Mapping service providers (e.g., operators of a mapping platform 101) often utilizes a large number of data sources 103a-103j (also collectively referred to as data sources 103) to create their maps (e.g., digital map data of a geographic database 105), each data source 103 with differing levels of quality and accuracy. In one embodiment, to understand the strengths and limitations of every data source 103, the mapping platform 101 attempts to quantify the accuracy of data sources 103 through a process referred to as source characterization 107. By way of example, this process takes a large number of position measurements (e.g., sign locations or any other type of observable, sensor data, etc.) collected from a data source 103 and compares these positions to the “true” positions indicated by a trusted and highly accurate source of the same features (e.g., at meter or sub-meter levels of accuracy). Examples of “true” positions include, but are not limited to ground control measurements of the same features by the trusted and highly accurate source (e.g., the same sign positions measured by the control source).

Using many measurements (e.g., greater than a designated number of measurements collected from one or more sensors 109a-109n, also collectively referred to as sensors 109 of vehicles 111a-111n, also collectively referred to as vehicles 111, by the mapping platform 101 over a communication network 113), the corresponding error (compared to ground control measurements) can be analyzed and statistically characterized by its mean and error covariance matrix. An error covariance matrix, for instance, is a square matrix that describes the covariance between the errors in a set of measured values. The diagonal elements of the error covariance matrix represent the variances of individual errors, and the off-diagonal elements represent the covariances between pairs of errors. The empirically measured error covariance matrix then describes the characteristic behavior of the sensor 109 used to make the measurement, in terms of the spatial accuracy of its position measurements. Although the various embodiments discussed herein are described with respect to positional accuracy or error, it is contemplated that the statistical behavior of any other aspects of sensor performance can also be measured by source characterization according to the various embodiments described herein.

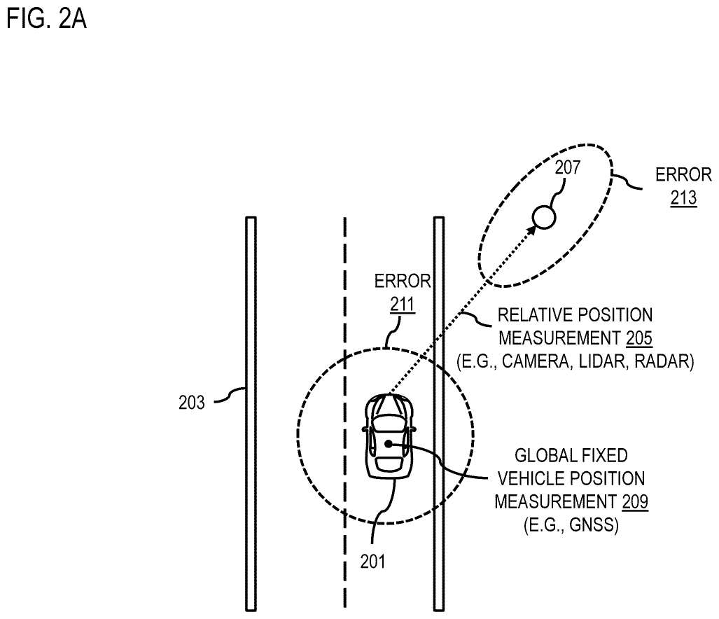

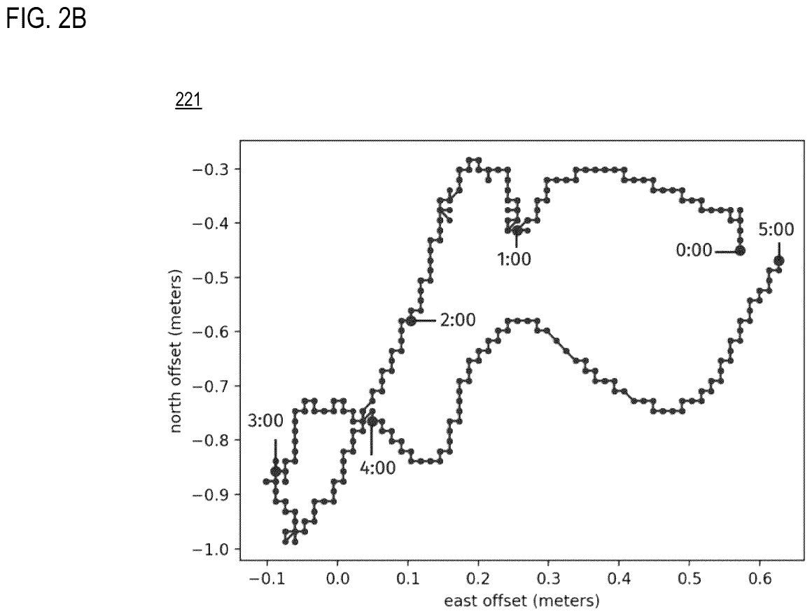

Measuring positional accuracy is complicated by the fact that multiple sources of error compound, so any positional offset from a measurement to ground control actually captures the net error introduced by several errors. Specifically, a terrestrial capture system does not directly estimate the absolute position of features (e.g., signs) on the Earth (e.g., a global frame of reference); rather, the system provides a conglomerate of measurements (GPS for vehicle position, odometry for vehicle displacement, and relative position of signs), from which global positions of detections can be inferred. FIG. 2A is a diagram illustrating a relative position measurement, according to one example embodiment. As shown, as a vehicle 201 equipped with a sensor (e.g., a camera system, LiDAR, radar, or equivalent, not shown) travels on a road 203, the sensor or camera system measures the relative position 205 (e.g., in x meters forward, y meters left, and z meters up) of a detected sign 207 (or any other detectable object) from the vehicle 201 at a time, t, while the global fixed vehicle position 209 at time t is measured by the system's Global Navigation Satellite System (GNSS) unit (e.g., GPS or equivalent). Thus, the global position of the sign 207 is computed from two measurements (e.g., global fixed vehicle position measurement 209 and relative sign position measurement 205), and each of these measurements are themselves noisy, and inaccurate. Source characterization attempts to isolate these individual sources of error to measure their effects separately. Specifically, the mapping platform 101 aims to compute a covariance matrix for the GNSS/GPS error 211 and another covariance matrix for the error 213 of the measured relative positions of object detections (e.g., signs).

Isolating the error sources would be simple if there were available ground control for the position of the vehicle 201—in this way, the mapping platform 101 could compare the GNSS/GPS-measured vehicle positions (e.g., global fixed vehicle position measurement 209) to this ground control to determine the GNSS/GPS error 211. However, the true position of the vehicle 201, in most cases, is lost to history, with only the noisy GNSS/GPS measurements to show for it. In contrast, ground control can be created for the absolute position of observables (e.g., signs), through independent measurements and verification. Nonetheless, designing methods for source characterization is technically challenging since multiple error sources must be identified, modelled, and then systematically isolated for empirical measurement.

In one traditional approach, source characterization has proposed a way to isolate the sources of error by first shifting the position of vehicle pose paths to “undo” the GNSS/GPS error (e.g., global position measurement error), and subsequently measure the accuracy of the relative position measurements (e.g., the forward-left-up measurements of detected positions of road objects such as but not limited to signs). This process leverages the fact that GNSS/GPS error varies relatively slowly. For illustration, FIG. 2B is a diagram illustrating positioning error drift over time for a satellite-based positioning system, according to one example embodiment. More specifically, FIG. 2B illustrates a graph 221 where a stationary GNSS/GPS unit logged measurements of its unchanging position over the course of five minutes. As shown, the measured position slowly drifts on the order of meters over the course of minutes, but from one second to the next, the position is relatively constant.

At any given moment (say, across a 10-second interval), the error of GNSS/GPS measurements is unknown, and relatively constant. Thus, any positions of a single vehicle measured within a short interval (e.g., 10-second interval or distance traveled by the vehicle over 10 seconds) will all be offset by the same unknown constant amount. Source characterization considers all features which were detected within such a short interval; every feature's absolute position can be estimated as the vehicle position (which is offset by an unknown constant) plus the measured relative displacement (meters forward-left-up, which itself contains random perturbation from noise). The absolute feature positions detected in a short interval are then compared to ground control; when there are many such features, then the average measurement-to-control offset across these features will be a good estimate of the unknown constant GNSS/GPS error. This is because the relative error is independent from measurement-to-measurement, so that the averaging operation will cancel out the many differing relative errors, and leave only the constant GNSS/GPS offset.

GPS error over short intervals is measured this way, and then vehicle position measurements are corrected by removing the estimated GPS error. After this shift, the absolute feature positions will be subject only to the noise in the relative position measurements, allowing the mapping platform 101 to measure their covariance, independent of GNSS/GPS noise.

However, this approach to GPS correction relies heavily on having a large number of detections made within a short interval, and that they all have corresponding ground control position estimates. This is necessary for this approach in order for the averaging operation to remove the effect of the noise from the individual measurements, and leave only the GNSS/GPS error. In particular, if N measurements are averaged, then the noise in this average itself has a variance which is N times less than the original noise variance. A large number (e.g., N>20) are used to sufficiently reduce the noise enough to extract the constant GNSS/GPS offset. Obtaining more than 20 detections with ground control is rather uncommon, and so the current approach is not very effective in practice. Thus, mapping service providers still face significant technical challenges with respect to source characterization to determine relative position measurement error for a sensor.

To address these technical challenges, the system 100 of FIG. 1 introduces a capability to isolate the error in the relative position measurements from the global measurement error, e.g., associated with the GNSS/GPS error. It is noted that the error distribution of GNSS/GPS does not need to be known, only that the noise is relatively constant for the period of time the relative position measurement is made. For example, the error distribution of GNSS/GPS is not Gaussian, and the measurement error distribution is not guaranteed to Gaussian but, in some embodiment, the Gaussian assumption allows the calculations to be made without knowing the actual error distribution.

In one embodiment, the mapping platform 101 does this using N=2 positions measured within a short time or distance span (e.g., within 10 seconds or within a distance the capturing vehicle 111 travels in 10 seconds), which is more accessible than the N>20 measurements required in the traditional approach described above. In one embodiment, the mapping platform 101 uses linear mathematical operations to obtain a least-squares estimate for the covariance matrix of relative position measurements based on the use of position differences, rather than the positions, to measure accuracy.

In other words, the mapping platform 101 determines the error of the sensor 109 used for the relative position measurements by estimating the relevant covariance matrix from the covariance matrix of the position differences.

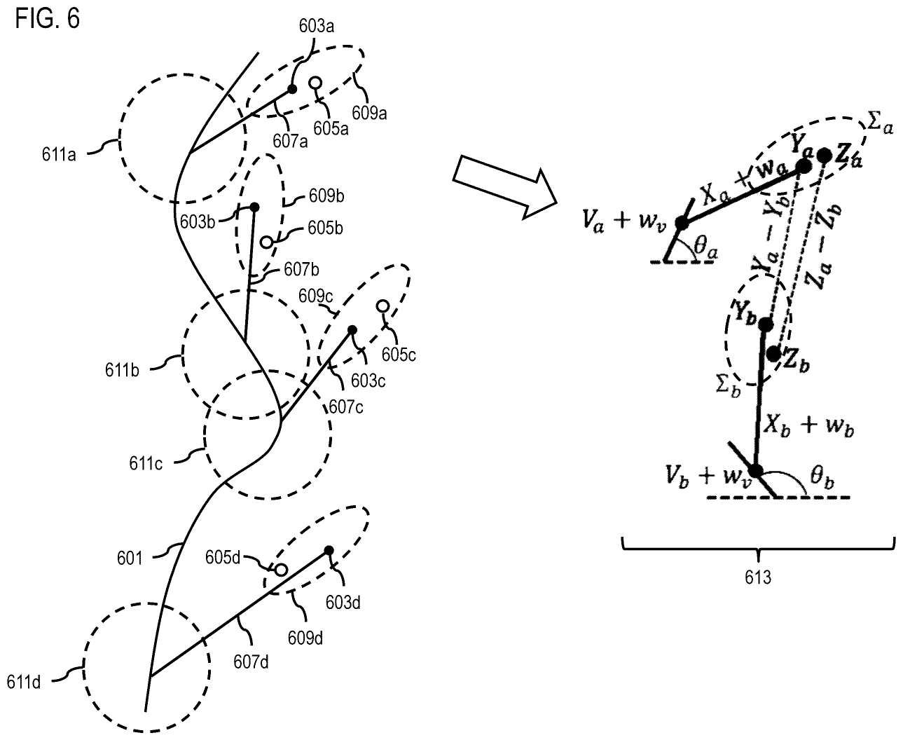

More specifically, in one example embodiment, the mapping platform 101 performs the following:
1. Find N pairs of point features, {(a₁, b₁), (a₂, b₂), . . . , (a_{N}, b_{N})}, where the individual pairs of features (aₙ, bₙ) are close together (e.g., within a time or distance threshold), but the pairs themselves may be far apart (e.g., an may be far from bₘ for m≠n)
2. Extract the measured positions Yₐ_{ₙ} and Y_{b}_{ₙ} of the point feature pairs in each of one or more (e.g., greater than 20) drives—it is possible to use a different set of drives for every pair of features. Compute Yₐ_{ₙ}-Y_{b}_{ₙ} for each drive, and compute the sample covariance, Σ^{Y}^{ₙ}, over these samples.
3. Take the known vehicle pose (e.g., determined based on the orientation of the road or other equivalent means) θₐ_{ₙ} and θ_{b}_{ₙ} at these observations, and compute the corresponding 3×3 matrices A_{3×3} (θₐ_{ₙ}) and A_{3×3} (θ_{b}_{ₙ}) explained in more detail in Equation 6 below with respect to FIG. 6.
4. Estimate the error of the relative position measurements based on the elements of the covariance matrix of the relative position measurement, Σ^{w}, with the pseudoinverse calculation in Equation 8 as explained in more detail below with respect to FIG. 6.

The various embodiments described herein for measuring error of relative position data provides for at least the following technical advantages:
The various embodiments described herein can estimate the error or covariance of the relative position measurements using far fewer measurements in close proximity; e.g., uses one or more pairs of measurements (e.g., at least two measurements in one pair), where the position measurement in a pair are in close proximity (e.g., within a time or distance threshold). Previous approaches required >20 measurements.
Previous approaches require accurate positions of ground truth data, while the various embodiments described herein do not because they rely on measurement differences and not on the measurements themselves.

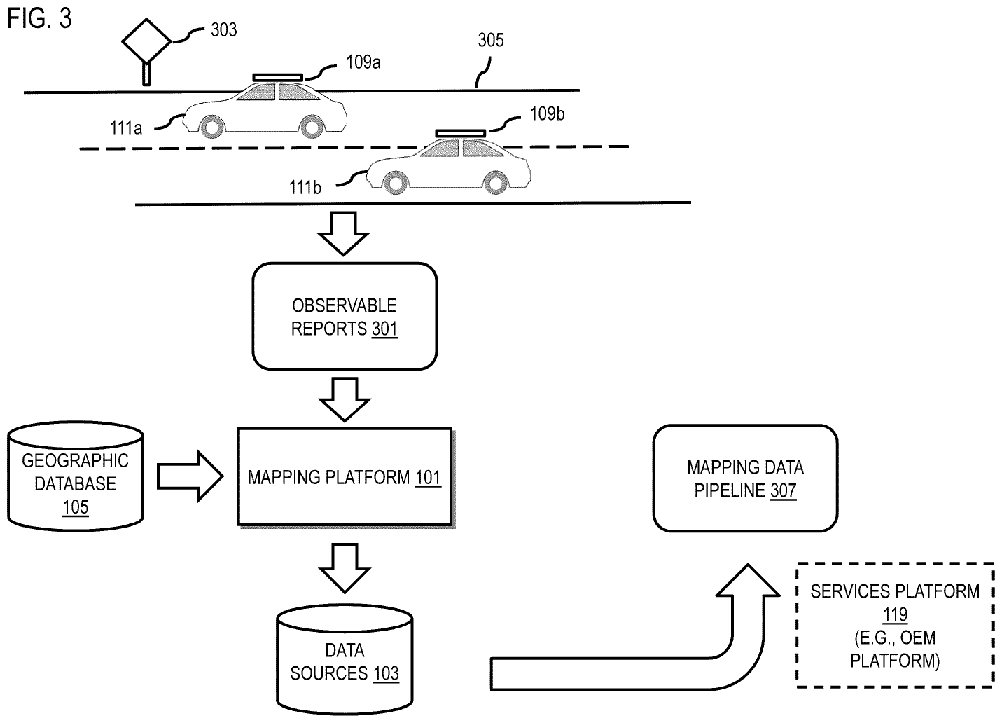

FIG. 3 is a diagram illustrating a data pipeline (e.g., real-time or batch processing pipeline) for measuring error in relative position data from a sensor, according to one embodiment. In one embodiment, the process for measuring error in relative position data from a sensor can be performed as part of an automated and/or manual mapping pipeline as shown in FIG. 3. Automated refers, for instance, to operating the pipeline without manual intervention in all or a portion of the pipeline from data ingestion to output of the measured error for the relative position data. Thus, the various embodiments described herein provide technical improvements to the map making pipeline or system 100 by introducing a process for measuring error based on measured positional data instead of the measurements themselves to reduce the number of samples and eliminate the need for ground truth. As shown, the mapping platform 101 receives observable reports 301 (e.g., sensor data reports that include detected road objects 303—e.g., point features such as signs and/or the like—from a vehicle 111a/111b equipped with sensors 109a/109b) as the vehicle 111a/111b travels on a road 305.

The mapping platform 101 aggregates and analyzes the observable reports 301 (e.g., from one or more vehicles 111) to measure relative position data from a sensor 109 according to the various embodiments described herein. In one embodiment, the determined error can be used to evaluate data sources 103 for inclusion in the mapping data pipeline 307. The mapping data pipeline 307, for instance, can process the data sources 103 selected for inclusion based on their measured error to generate digital map data of the geographic database 105 and/or to provide location-based services. The mapping data pipeline 307, for instance, can further process, verify, format, etc. the error data, relative position data, data sources 103, etc. before publication, use, or updating of the digital map data of the geographic database 105.

In one embodiment, the mapping platform 101 can use any architecture for transmitting the observable reports 301, measured error, and/or related information to the end user devices (e.g., the vehicle 111, client terminal 115 executing a client application 117, etc.) over a communication network 113. In one embodiment, the mapping platform 101 can also transmit or publish the intersection data to a third-party services platform 119, any services 121a-121m (also collectively referred to as services 121) of the services platform 119, one or more content providers 123a-123k (also collectively referred to as content providers 123). When performing direct publishing, the transmission of the intersection data is performed over the communication network 113 between the mapping platform 101 and one or more user devices (e.g., the vehicles 111, client terminal 115, etc.) directly. When publishing via a third-party, the transmission of the intersection data is performed over the communication network 113 between the mapping platform 101 and a third-party provider such as the services platform 119 (e.g., a vehicle OEM platform), services 121, and/or content providers 123.

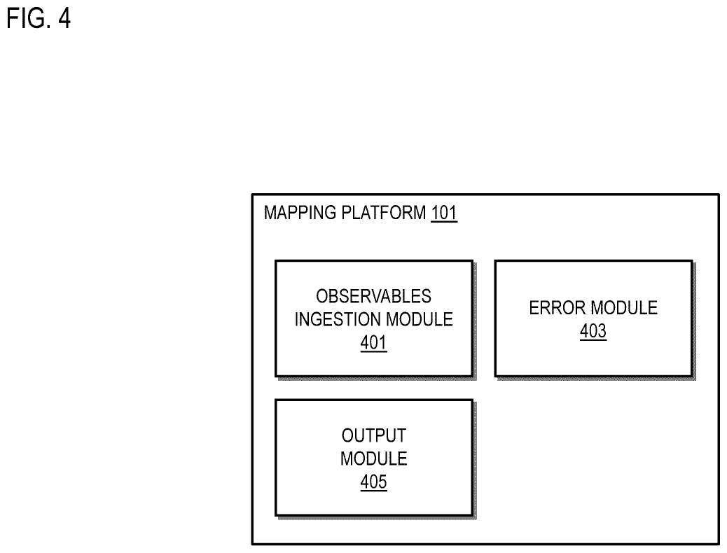

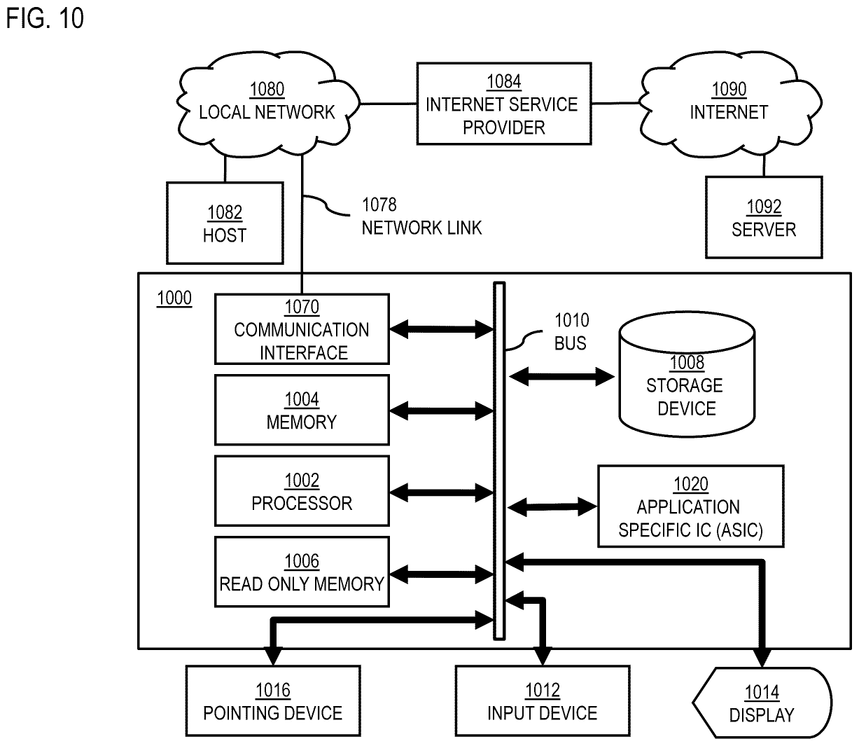

FIG. 4 is a diagram of the components of a mapping platform 101, according to one example embodiment. By way of example, the mapping platform 101 includes one or more components for measuring error in relative position data from a sensor, according to the various embodiments described herein. It is contemplated that the functions of these components may be combined or performed by other components of equivalent functionality. In one embodiment, the mapping platform 101 includes an observables ingestion module 401, an error module 403, and an output module 405. The above presented modules and components of the mapping platform 101 can be implemented in hardware, firmware, software, or a combination thereof such as but not limited to the hardware illustrated in FIGS. 10-12. Though depicted as a separate entity in FIG. 1, it is contemplated that the mapping platform 101 may be implemented as a module of any of the components of the system 100 (e.g., a component of the vehicle 111, services platform 119, services 121, content providers 123, client terminal 115, application 117, etc.). In another embodiment, one or more of the modules 401-405 may be implemented as a cloud based service, local service, native application, or combination thereof. The functions of the mapping platform 101 and the modules 401-405 are discussed with respect to the figures below.

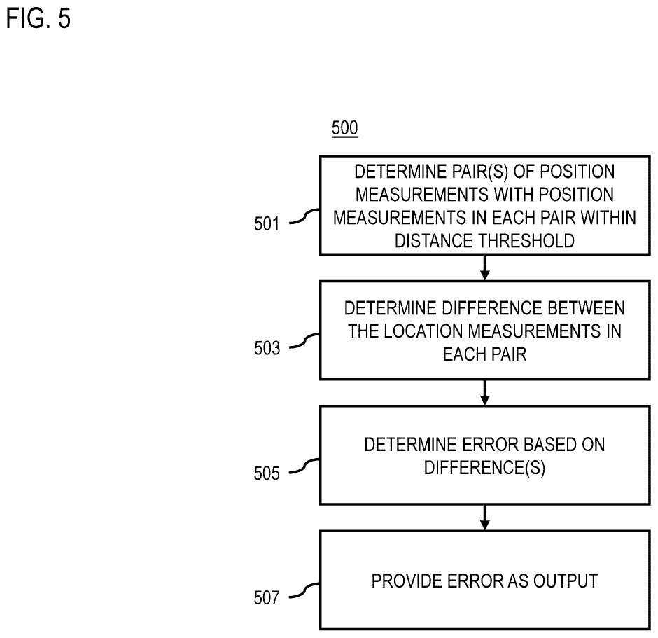

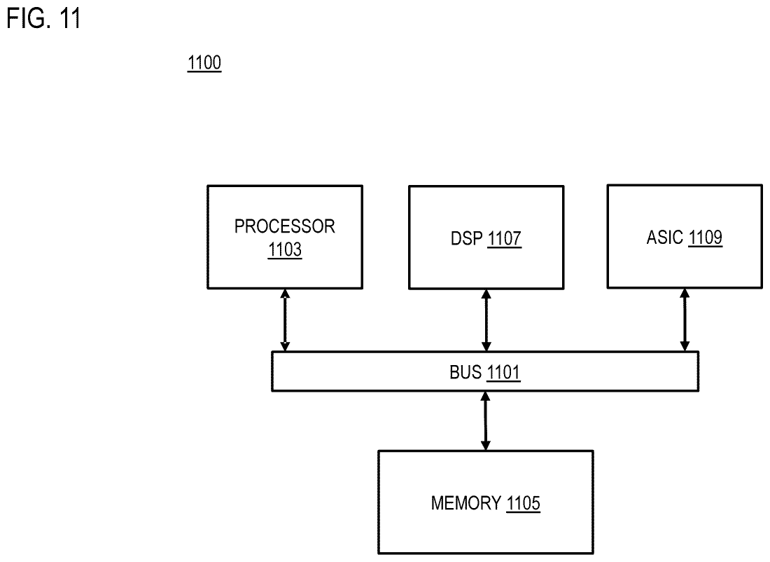

FIG. 5 is a flowchart of a process 500 for measuring error in relative position data from a sensor, according to one example embodiment. In various embodiments, the mapping platform 101 and/or any of the modules 401-405 of the mapping platform 101 may perform one or more portions of the process 500 and may be implemented in, for instance, a chip set including a processor and a memory as shown in FIG. 11 or in circuitry, hardware, firmware, software, or in any combination thereof. As such, the mapping platform 101 and/or the modules 401-405 can provide means for accomplishing various parts of the process 500, as well as means for accomplishing embodiments of other processes described herein in conjunction with other components of the system 100. Although the process 500 is illustrated and described as a sequence of steps, it is contemplated that various embodiments of the process 500 may be performed in any order or combination and need not include all of the illustrated steps.

The process 500 is directed to the address the technical challenges associated with measuring error in relative position data as described above. These technical challenges are further illustrated in FIG. 6, which is a diagram of an example set of relative positioning measurements, according to one example embodiment. In the example of FIG. 6, consider that there are several drives (e.g., drives along trajectory 601) passing through a scene, and that each drive detects a number of fixed point feature landmarks 603a-603d (also collectively referred to as landmarks 603) for which the mapping platform 101 also has accurate, trusted ground control measurements 605a-605d (also collectively referred to as ground control measurements 605) of their true positions. As the drives traverse the scene, they record frequent GNSS/GPS measurements of the vehicle's absolute (world) position, and these measurements are corrupted by slow-varying noise. When the vehicle (not shown) draws near and passes by the point landmarks 603a-603d, the vehicle records a single measurement of the position of each landmark 603a-603d as respective displacements 607a-607d (also collectively referred to as displacements 607) from the vehicle position in relative coordinates (e.g., meters forward-left-up) at the time of capture. Each of these relative position measurements are also corrupted by respective noise 609a-609d (e.g., represented as ovals and also collectively referred to as noise 609), which is Gaussian-normally distributed, and independent and identically distributed (iid) for every measurement. The technical challenge or problem is associated with estimating the covariance of the iid relative measurement noise 609 using measurements from the drives.

This problem is illustrated in FIG. 6. For example, FIG. 6 shows the trajectory 601 of a single vehicle. The GNSS/GPS measurements of the trajectory 601 are also corrupted by noise 611a-611d (also collectively referred to as noise 611), with its covariance shown as noise circles 611 (thus, the mapping platform 101 cannot be certain where the vehicle truly is). Along the trajectory 601, the vehicle observes four point feature landmarks 603a-603d that are truly located as the respective ground control measurements 605a-605d. The relative position measurement of these point features 603 are depicted as respective displacements 607a-607d, indicating their relative position (meters forward-left-up) from the vehicle position on the trajectory 601. Thus, the estimated positions of the point feature are shown with dots at the ends of the displacement lines 607. The relative position measurements indicated by the displacements 607 are also corrupted by Gaussian noise with covariance ellipses shown as respective noise 609a-609b. Thus, the estimated position of the point features (e.g., represented by the black dots denoting features 603a-603d) are subject to two sources of noise: (1) the noise 611 in the pose path measurement and the noise 609 in the relative displacement 607. One goal of the process 500 is to eliminate the impact of the noise 611 from the pose path (e.g., trajectory 601), and measure the unknown noise covariance of the relative measurements (e.g., noise 609) in isolation.

First, the process 500 invokes the assumption that the GNSS/GPS noise 611 is slowly varying. Thus, the pose path (e.g., trajectory 601) is offset by an unknown amount which is approximately constant for the illustrated short snippet of the drive. This is because the short snippet of the drive is drivable within the time that the GNSS/GPS noise 611 is expected to remain constant within a designated range. Thus, all the measurements illustrated in FIG. 6 (e.g., trajectory 601, displacements 607, and features 603) are shifted by the same, unknown constant amount.

FIG. 6 also illustrates an example 613 of a section of the trajectory 601 associated with features 603a (denoted by the variable “a” in example 613) and 603b (denoted by the variable “b” in example 613) that lists variables to introduce some formal notation. More specifically, let two-dimensional (2D) column vector Vᵢ indicate the vehicle's true 2D position (e.g., measured at ground control points 605 corresponding to variable Zᵢ) at the time of measuring feature i (e.g., features 603), and 2×2 rotation matrix Rᵢ expresses the vehicle's true pose (e.g., denoted by angle θᵢ) at that time; i.e. the rotation matrix, expressed in terms of the trajectory angle, θᵢ, transforms local forward-left-up (FLU) coordinates (e.g., a local frame of reference centered on the vehicle) to world East-North-Up (ENU) coordinates (e.g., a global frame of reference referencing on fixed point on the Earth's surface):

$${R}_{i} = R ( {θ}_{i} ) = [ \begin{matrix}cos {θ}_{i} & - sin {θ}_{i} \\ sin {θ}_{i} & cos {θ}_{i}\end{matrix} ] . \qquad Equation 1$$

The process 500 presumes that this orientation is known, since vehicles travel in a predictable path along a road so that their orientation is always along the road's orientation; and further, the direction of vehicle trajectory can be accurately inferred from GPS measurements, as it is not impacted by the noise corruption. In one embodiment, the road's orientation can be queried from the digital map data of the geographic database 105. Let Zᵢ be the true position of point feature i, and Xᵢ be the true FLU offset to the point feature at Zᵢ from the vehicle at Vᵢ; i.e. Zᵢ=Vᵢ+RᵢXᵢ.

The vehicle's on-board sensors (e.g., sensors 109 of vehicles 111) collect measurements of the vehicle's position (e.g., vehicle positioning sensors such as GNSS/GPS receivers) and the relative position of observables. These measurements are offset by random noise so that the recorded values differ from the ideal ones. In particular, the GPS-measured vehicle position is offset by an unknown constant 2D noise vector, w_{V}, (e.g., corresponding to noise 611) so that its measured position is Vᵢ+w_{V}; recall that the GNSS/GPS noise is slowly varying, so that all features, i, measured within a short duration (e.g., within 10 seconds or other designated time or distance threshold) are all offset by the same unknown constant, w_{V}. On the other hand, the measured FLU position Xᵢ of the point feature is offset by Gaussian noise, wᵢ, (corresponding to noise 609) which varies with each measurement, but is identically and independently distributed (iid) (e.g., having the same probability distribution but does not affect each other), so that the measured offset is Xᵢ+wᵢ. In one embodiment, a goal of the process 500 is to empirically characterize the statistics of this noise, wᵢ (e.g., noise 609).

Combining all of these results, now indicate the measured global position Yᵢ of point feature i as the sum of the measured vehicle position Vᵢ+w_{V} and the measured displacement Rᵢ (Xᵢ+wᵢ):

$${Y}_{i} = ( {V}_{i} + {w}_{V} ) + {R}_{i} ( {X}_{i} + {w}_{i} )$$

Computing the displacement between Yᵢ and the ground truth position Zᵢ=Vᵢ+Xᵢ leaves a combination of both noise terms.

$${Y}_{i} - {Z}_{i} = ( {V}_{i} + {w}_{V} ) + {R}_{i} ( {X}_{i} + {w}_{i} ) - ( {V}_{i} + {X}_{i} ) = {w}_{V} + {R}_{i} {w}_{i} .$$

However, the process 500 is directed to isolating wᵢ, so instead, the process 500 takes the difference of measurements of two point features, say a (e.g., corresponding to feature 603a) and b (e.g., corresponding to feature 603b) that are captured with a time or distance threshold of each other (e.g., referred to as a pair of position measurements):

$$\begin{matrix}{Y}_{a} - {Y}_{b} = [ ( {V}_{a} + {w}_{V} ) + {R}_{a} ( {X}_{a} + {w}_{a} ) ] - [ ( {V}_{b} + {w}_{V} ) + {R}_{b} ( {X}_{b} + {w}_{b} ) ] \\ = ( {V}_{a} + {R}_{a} {X}_{a} + {R}_{a} {w}_{a} ) - ( {V}_{b} + {R}_{b} {X}_{b} + {R}_{b} {w}_{b} ) \\ = ( {Z}_{a} + {R}_{a} {w}_{a} ) - ( {Z}_{b} + {R}_{b} {w}_{b} )\end{matrix}$$

Notice here that the constant noise term, w_{V}, has been eliminated. By subtracting off the ground control difference, two of the desired noise terms are left:

$$\begin{matrix}( {Y}_{a} - {Y}_{b} ) - ( {Z}_{a} - {Z}_{b} ) = [ ( {Z}_{a} + {R}_{a} {w}_{a} ) - ( {Z}_{b} + {R}_{b} {w}_{b} ) ] - [ {Z}_{a} - {Z}_{b} ] \\ = {R}_{a} {w}_{a} - {R}_{b} {w}_{b} ,\end{matrix}$$

where, as mentioned, rotation matrices Rₐ and R_{b} are known.

One goal of the process 500 work is to empirically deduce the covariance matrix for the observation noise, wᵢ, which is iid and Gaussian (i.e., normally distributed). Using the above expressions, the covariance can be expressed as:

$$Cov [ ( {Y}_{a} - {Y}_{b} ) - ( {Z}_{a} - {Z}_{b} ) ] = Cov [ {R}_{a} {w}_{a} - {R}_{b} {w}_{b} ] = Cov [ {R}_{a} {w}_{a} ] + Cov [ {R}_{b} {w}_{b} ] = {R}_{a} Cov [ {w}_{a} ] {R}_{a}^{T} + {R}_{b} Cov [ {w}_{b} ] {R}_{a}^{T}$$

In fact, the use of the ground control expression (i.e., (Zₐ−Z_{b})) is not even needed here, noting that the covariance of the measured difference Yₐ−Y_{b} (i.e., the difference between position measurement a and b) is the same expression:

$$Cov [ {Y}_{a} - {Y}_{b} ] = Cov [ {R}_{a} {w}_{a} - {R}_{b} {w}_{b} ] = {R}_{a} Cov [ {w}_{a} ] {R}_{a}^{T} + {R}_{b} Cov [ {w}_{b} ] {R}_{a}^{T}$$

Let Σ^{Y} denote the 2×2 covariance matrix Cov[Yₐ−Y_{b}], and Σ^{w} denote the 2×2 covariance matrix Cov [wᵢ], then these matrices can be related as:

$${\sum }^{Y} = {R}_{a} {\sum }^{w} {R}_{a}^{T} + {R}_{b} {\sum }^{w} {R}_{b}^{T} . \qquad Equation 2$$

Note that Σ^{Y} can be measured empirically, by obtaining many samples of measured positions, Yₐ and Y_{b} from different drives. Each measurement will differ, due to the underlying noise wᵢ, and so the sample covariance matrix, Σ^{Y}, captures this variation. While Σ^{Y} is simple to measure, it unfortunately is not useful on its own-Recall that a goal of the process 500 is instead to find the 2×2 covariance Σ^{W} (which models the unknown system noise). Thus, the process 500 is directed to deriving an estimate for Σ^{w} by using the sample covariance Y. The process 500 may do so by expanding Equation 2 which relates Σ^{Y} to Σ^{w} via terms of the known rotation matrices Rₐ and R_{b}.

In particular, denote Σⁱ=RᵢΣ^{w}Rᵢ^{T}:

$${\sum }^{i} = [ \begin{matrix}{\sum }_{1 , 1}^{i} & {\sum }_{1 , 2}^{i} \\ {\sum }_{1 , 2}^{i} & {\sum }_{2 , 2}^{i}\end{matrix} ] = {R}_{i} {\sum }^{w} {R}_{i}^{T} = [ \begin{matrix}cos {θ}_{i} & - sin {θ}_{i} \\ sin {θ}_{i} & cos {θ}_{i}\end{matrix} ] [ \begin{matrix}{\sum }_{1 , 1}^{w} & {\sum }_{1 , 2}^{w} \\ {\sum }_{1 , 2}^{w} & {\sum }_{2 , 2}^{w}\end{matrix} ] [ \begin{matrix}cos {θ}_{i} & sin {θ}_{i} \\ - sin {θ}_{i} & cos {θ}_{i}\end{matrix} ] . \qquad Equation 3$$

Now, explicitly carrying out the matrix multiplications, the process 500 may derive a form for each of the three unique elements of Σⁱ in terms of the known vehicle pose, θᵢ, and the unknown elements of noise covariance Σ^{W}:

$${\sum }_{1 , 1}^{i} = {cos}^{2} {θ}_{i} {\sum }_{1 , 1}^{w} - 2 sin {θ}_{i} cos {θ}_{i} {\sum }_{1 , 2}^{w} + {sin}^{2} {θ}_{i} {\sum }_{2 , 2}^{w}$$

$${\sum }_{1 , 2}^{i} = sin {θ}_{i} cos {θ}_{i} {\sum }_{1 , 1}^{w} + ( {cos}^{2} {θ}_{i} - {sin}^{2} {θ}_{i} ) {\sum }_{1 , 2}^{w} - sin {θ}_{i} cos {θ}_{i} {\sum }_{2 , 2}^{w}$$

$${\sum }_{2 , 2}^{i} = {sin}^{2} {θ}_{i} {\sum }_{1 , 1}^{w} + 2 sin {θ}_{i} cos {θ}_{i} {\sum }_{1 , 2}^{w} + {cos}^{2} {θ}_{i} {\sum }_{2 , 2}^{w} .$$

Rewriting as a matrix multiplication:

$$( \begin{matrix}{\sum }_{1 , 1}^{i} \\ {\sum }_{1 , 2}^{i} \\ {\sum }_{2 , 2}^{i}\end{matrix} ) = [ \begin{matrix}{cos}^{2} {θ}_{i} & - 2 sin {θ}_{i} cos {θ}_{i} & {sin}^{2} {θ}_{i} \\ sin {θ}_{i} cos {θ}_{i} & ( {cos}^{2} {θ}_{i} - {sin}^{2} {θ}_{i} ) & - sin {θ}_{i} cos {θ}_{i} \\ {sin}^{2} {θ}_{i} & 2 sin {θ}_{i} cos {θ}_{i} & {cos}^{2} {θ}_{i}\end{matrix} ] ( \begin{matrix}{\sum }_{1 , 1}^{w} \\ {\sum }_{1 , 2}^{w} \\ {\sum }_{2 , 2}^{w}\end{matrix} ) , \qquad Equation 4$$

Finally, by simplifying notation, Equation 4 can be rewritten as:

$${\vec{\sum }}_{3 \times 1}^{i} = {A}_{3 \times 3} ( {θ}_{i} ) {\vec{\sum }}_{3 \times 1}^{w} , \qquad Equation 5$$

$$where$$

$${A}_{3 \times 3} ( {θ}_{i} ) {=}^{Δ} [ \begin{matrix}{cos}^{2} {θ}_{i} & - 2 sin {θ}_{i} cos {θ}_{i} & {sin}^{2} {θ}_{i} \\ sin {θ}_{i} cos {θ}_{i} & ( {cos}^{2} {θ}_{i} - {sin}^{2} {θ}_{i} ) & - sin {θ}_{i} cos {θ}_{i} \\ {sin}^{2} {θ}_{i} & 2 sin {θ}_{i} cos {θ}_{i} & {cos}^{2} {θ}_{i}\end{matrix} ] , {\vec{\sum }}_{3 \times 1}^{i} = ( \begin{matrix}{\sum }_{1 , 1}^{i} \\ {\sum }_{1 , 2}^{i} \\ {\sum }_{2 , 2}^{i}\end{matrix} ) , {\vec{\sum }}_{3 \times 1}^{w} = ( \begin{matrix}{\sum }_{1 , 1}^{w} \\ {\sum }_{1 , 2}^{w} \\ {\sum }_{2 , 2}^{w}\end{matrix} ) . \qquad Equation 6$$

Now, recall the identity from Equation 2

$${\sum }^{Y} = {R}_{a} {\sum }^{w} {R}_{a}^{T} + {R}_{b} {\sum }^{w} {R}_{b}^{T} = {\sum }^{a} + {\sum }^{b} .$$

Now since Equation 4 allows expanding Σ^{a} and Σ^{b} elements in terms of Σ^{w}, then the following equation is arrived at:

$${\vec{\sum }}_{3 \times 1}^{Y} = [ {A}_{3 \times 3} ( {θ}_{a} ) + {A}_{3 \times 3} ( {θ}_{b} ) ] {\vec{\sum }}_{3 \times 1}^{w} ⇒ {\vec{\sum }}_{3 \times 1}^{w} = {[ {A}_{3 \times 3} ( {θ}_{a} ) + {A}_{3 \times 3} ( {θ}_{b} ) ]}^{- 1} {\vec{\sum }}_{3 \times 1}^{Y} . \qquad Equation 7$$

In one embodiment, based on the derivation above, the process 500 has what is needed to estimate the observation noise covariance, Σ^{w}, for the case of a pair of point measurements or point features as follows:
1. Find two point features, a and b, which are close together (so that GPS noise is constant between the observations) (e.g., step 501).
2. Extract the measured positions, Yₐ and Y_{b}, for many (e.g., >20 or any other designated number of drives depending on the confidence level for computing the error in relative position data) drives. Compute Yₐ−Y_{b} for each drive (e.g., 503), and compute the sample covariance, Σ^{Y}, over these samples (e.g., step 505).
3. Take the known vehicle pose (the orientation of the road) θₐ_{ₙ} and θ_{b}_{ₙ} at these observations, and compute the corresponding 3×3 matrices A_{3×3}(θₐ_{ₙ}) and A_{3×3}(θ_{b}_{ₙ}) using Equation 6 (e.g., step 505).
4. Estimate the elements of Σ^{w} using Equation 7 (e.g., step 505).

In one embodiment, the process 500 can be further improved by generalizing further. Consider now that instead of a single pair of point features (a, b), that the process 500 has a collection of N pairs {(a₁, b₁), (a₂, b₂), . . . , (a_{N}, b_{N})} (i.e., multiple or a plurality of pairs of position measurements). In this case, the covariance of each difference pair can be calculated; i.e. sample covariance Σ^{Y}^{ₙ}=Cov[Yₐ_{ₙ}−Y_{b}_{ₙ}] can be calculated and related to the unknown covariance Σ^{w}, as above. In this case, we can relate the N sets of relationships as:

$${( \begin{matrix}{\vec{\sum }}_{3 \times 1}^{{Y}_{1}} \\ {\vec{\sum }}_{3 \times 1}^{{Y}_{2}} \\ ⋮ \\ {\vec{\sum }}_{3 \times 1}^{{Y}_{N}}\end{matrix} )}_{3 N \times 1} = {[ \begin{matrix}{A}_{3 \times 3} ( {θ}_{{a}_{1}} ) + {A}_{3 \times 3} ( {θ}_{{b}_{1}} ) \\ {A}_{3 \times 3} ( {θ}_{{a}_{2}} ) + {A}_{3 \times 3} ( {θ}_{{b}_{2}} ) \\ ⋮ \\ {A}_{3 \times 3} ( {θ}_{{a}_{N}} ) + {A}_{3 \times 3} ( {θ}_{{b}_{N}} )\end{matrix} ]}_{3 N \times 3} {\vec{\sum }}_{3 \times 1}^{w}$$

So, then the desired matrix is extracted via a pseudoinverse of the 3N×3 matrix:

$${\vec{\sum }}_{3 \times 1}^{w} = {[ \begin{matrix}{A}_{3 \times 3} ( {θ}_{{a}_{1}} ) + {A}_{3 \times 3} ( {θ}_{{b}_{1}} ) \\ {A}_{3 \times 3} ( {θ}_{{a}_{2}} ) + {A}_{3 \times 3} ( {θ}_{{b}_{2}} ) \\ ⋮ \\ {A}_{3 \times 3} ( {θ}_{{a}_{N}} ) + {A}_{3 \times 3} ( {θ}_{{b}_{N}} )\end{matrix} ]}_{3 N \times 3}^{†} {( \begin{matrix}{\vec{\sum }}_{3 \times 1}^{{Y}_{1}} \\ {\vec{\sum }}_{3 \times 1}^{{Y}_{2}} \\ ⋮ \\ {\vec{\sum }}_{3 \times 1}^{{Y}_{N}}\end{matrix} )}_{3 N \times 1} \qquad Equation 8$$

In this case, the process 500 for multiple pairs of position measurements or point features is as follows:
1. Find N pairs of point features, {(a₁, b₁), (a₂, b₂), . . . , (a_{N}, b_{N})}, where the individual pairs of features (aₙ, bₙ) are close together, but the pairs themselves may be far apart (i.e. aₙ may be far from bₘ for m≠n) (e.g., step 501 with multiple pairs of point measurements) (e.g., step 501).
2. Extract the measured positions Yₐ_{ₙ} and Y_{b}_{ₙ} of the point feature pairs in each of many (>20) drives—it is possible to use a different set of drives for every pair of features. Compute Yₐ_{ₙ}−Y_{b}_{ₙ} for each drive (e.g., step 503), and compute the sample covariance, Σ^{Y}^{ₙ}, over these samples (e.g., step 505).
3. Take the known vehicle pose (the orientation of the road) θₐ_{ₙ} and θ_{b}_{ₙ} at these observations, and compute the corresponding 3×3 matrices A_{3×3}(θₐ_{ₙ}) and A_{3×3}(θ_{b}_{ₙ}) using Equation 6 (e.g., step 505).
4. Estimate the elements of Σ^{w} with the pseudoinverse calculation in Equation 8 (e.g., step 505).

To this point, the formulation was specific to a 2D case, where positions were expressed on a ground plane with no consideration for height. In one embodiment, the process 500 can be generalized to three-dimensions (3D) with very few modifications. In 3D, the process 500 can use 3-element column vectors to express the (x, y, z) position, so that the following are 3-element column vectors (instead of 2-element in plane positions):
Vehicle position, Yᵢ
Observation FLU vector, Xᵢ
Ground control position, Zᵢ
GPS noise w_{V}
Observation noise, wᵢ

Expressing pose in three dimensions can be more complicated, as a 3×3 rotation matrix Rᵢ will have three degrees-of-freedom, rather than the single degree of freedom, θᵢ, of the 2×2 rotation matrix from Equation 1:

$${R}_{i} = [ \begin{matrix}{R}_{1 , 1}^{i} & {R}_{1 , 2}^{i} & {R}_{1 , 3}^{i} \\ {R}_{2 , 1}^{i} & {R}_{2 , 2}^{i} & {R}_{2 , 3}^{i} \\ {R}_{3 , 1}^{i} & {R}_{3 , 2}^{i} & {R}_{3 , 3}^{i}\end{matrix} ]$$

Using this 3×3 matrix Rᵢ, then Equation 2 still holds for 3×3 covariance matrices Σ^{Y} and Σ^{w}. The equation Σⁱ=RᵢΣ^{w}Rᵢ^{T} can then be expanded as done in Equation 3:

$${\sum }^{i} = [ \begin{matrix}{\sum }_{1 , 1}^{i} & {\sum }_{1 , 2}^{i} & {\sum }_{1 , 3}^{i} \\ {\sum }_{1 , 2}^{i} & {\sum }_{2 , 2}^{i} & {\sum }_{2 , 3}^{i} \\ {\sum }_{1 , 3}^{i} & {\sum }_{2 , 3}^{i} & {\sum }_{3 , 3}^{i}\end{matrix} ] = {R}_{i} {\sum }^{w} {R}_{i}^{T} = [ \begin{matrix}{R}_{1 , 1}^{i} & {R}_{1 , 2}^{i} & {R}_{1 , 3}^{i} \\ {R}_{2 , 1}^{i} & {R}_{2 , 2}^{i} & {R}_{2 , 3}^{i} \\ {R}_{3 , 1}^{i} & {R}_{3 , 2}^{i} & {R}_{3 , 3}^{i}\end{matrix} ] [ \begin{matrix}{\sum }_{1 , 1}^{w} & {\sum }_{1 , 2}^{w} & {\sum }_{1 , 3}^{w} \\ {\sum }_{1 , 2}^{w} & {\sum }_{2 , 2}^{w} & {\sum }_{2 , 3}^{w} \\ {\sum }_{1 , 3}^{w} & {\sum }_{2 , 3}^{w} & {\sum }_{3 , 3}^{w}\end{matrix} ] [ \begin{matrix}{R}_{1 , 1}^{i} & {R}_{2 , 1}^{i} & {R}_{3 , 1}^{i} \\ {R}_{1 , 2}^{i} & {R}_{2 , 2}^{i} & {R}_{3 , 2}^{i} \\ {R}_{1 , 3}^{i} & {R}_{2 , 3}^{i} & {R}_{3 , 3}^{i}\end{matrix} ] .$$

Carrying out this matrix multiplication explicitly, a linear relationship similar to that from Equation 5 is arrived at as follows:

$${\vec{\sum }}_{6 \times 1}^{i} = {A}_{6 \times 6}^{i} {\vec{\sum }}_{6 \times 1}^{w} , \qquad Equation 9$$

$$Where$$

$$Equation 10$$

$${A}_{6 \times 6}^{i} = [ \begin{matrix}{( {R}_{1 , 1}^{i} )}^{2} & 2 {R}_{1 , 1}^{i} {R}_{1 , 2}^{i} & 2 {R}_{1 , 1}^{i} {R}_{1 , 3}^{i} & {( {R}_{1 , 2}^{i} )}^{2} & 2 {R}_{1 , 2}^{i} {R}_{1 , 3}^{i} & {( {R}_{1 , 3}^{i} )}^{2} \\ {R}_{1 , 1}^{i} {R}_{2 , 1}^{i} & ( {R}_{1 , 1}^{i} {R}_{1 , 2}^{i} + {R}_{1 , 1}^{i} {R}_{2 , 2}^{i} ) & ( {R}_{1 , 3}^{i} {R}_{2 , 1}^{i} + {R}_{1 , 1}^{i} {R}_{2 , 3}^{i} ) & {R}_{1 , 2}^{i} {R}_{2 , 2}^{i} & ( {R}_{1 , 3}^{i} {R}_{2 , 2}^{i} + {R}_{1 , 2}^{i} {R}_{2 , 3}^{i} ) & {R}_{1 , 3}^{i} {R}_{2 , 3}^{i} \\ {R}_{1 , 1}^{i} {R}_{3 , 1}^{i} & ( {R}_{1 , 1}^{i} {R}_{3 , 2}^{i} + {R}_{1 , 1}^{i} {R}_{3 , 2}^{i} ) & ( {R}_{1 , 3}^{i} {R}_{3 , 1}^{i} + {R}_{1 , 1}^{i} {R}_{3 , 3}^{i} ) & {R}_{1 , 2}^{i} {R}_{3 , 2}^{i} & ( {R}_{1 , 3}^{i} {R}_{3 , 2}^{i} + {R}_{1 , 2}^{i} {R}_{3 , 3}^{i} ) & {R}_{1 , 3}^{i} {R}_{3 , 3}^{i} \\ {( {R}_{2 , 1}^{i} )}^{2} & 2 {R}_{2 , 1}^{i} {R}_{2 , 2}^{i} & 2 {R}_{2 , 1}^{i} {R}_{2 , 3}^{i} & {( {R}_{2 , 2}^{i} )}^{2} & 2 {R}_{2 , 2}^{i} {R}_{2 , 3}^{i} & {( {R}_{2 , 3}^{i} )}^{2} \\ {R}_{2 , 1}^{i} {R}_{3 , 1}^{i} & ( {R}_{2 , 2}^{i} {R}_{3 , 1}^{i} + {R}_{2 , 1}^{i} {R}_{3 , 2}^{i} ) & ( {R}_{2 , 3}^{i} {R}_{3 , 1}^{i} + {R}_{2 , 1}^{i} {R}_{3 , 3}^{i} ) & {R}_{2 , 2}^{i} {R}_{3 , 2}^{i} & ( {R}_{2 , 3}^{i} {R}_{3 , 2}^{i} + {R}_{2 , 2}^{i} {R}_{3 , 3}^{i} ) & {R}_{2 , 3}^{i} {R}_{2 , 3}^{i} \\ {( {R}_{3 , 1}^{i} )}^{2} & 2 {R}_{3 , 1}^{i} {R}_{3 , 2}^{i} & 2 {R}_{3 , 1}^{i} {R}_{3 , 3}^{i} & {( {R}_{3 , 2}^{i} )}^{2} & 2 {R}_{3 , 2}^{i} {R}_{3 , 3}^{i} & {( {R}_{3 , 3}^{i} )}^{2}\end{matrix} ] ,$$

$${\vec{\sum }}_{6 \times 1}^{i} = ( \begin{matrix}{\sum }_{1 , 1}^{i} \\ {\sum }_{1 , 2}^{i} \\ {\sum }_{1 , 3}^{i} \\ {\sum }_{2 , 2}^{i} \\ {\sum }_{2 , 3}^{i} \\ {\sum }_{3 , 3}^{i}\end{matrix} ) , {\vec{\sum }}_{6 \times 1}^{w} = ( \begin{matrix}{\sum }_{1 , 1}^{w} \\ {\sum }_{1 , 2}^{w} \\ {\sum }_{1 , 3}^{w} \\ {\sum }_{2 , 2}^{w} \\ {\sum }_{2 , 3}^{w} \\ {\sum }_{3 , 3}^{w}\end{matrix} ) .$$

The estimate of 3×3 Σ^{w} follows the same steps as in the 2×2 case, but uses Equation 10 instead of Equation 6:

$${\vec{\sum }}_{6 \times 1}^{w} = {[ \begin{matrix}{A}_{6 \times 6}^{{a}_{1}} + {A}_{6 \times 6}^{{b}_{1}} \\ {A}_{6 \times 6}^{{a}_{2}} + {A}_{6 \times 6}^{{b}_{2}} \\ ⋮ \\ {A}_{6 \times 6}^{{a}_{N}} + {A}_{6 \times 6}^{{b}_{N}}\end{matrix} ]}_{6 N \times 6}^{†} {( \begin{matrix}{\vec{\sum }}_{6 \times 1}^{{Y}_{1}} \\ {\vec{\sum }}_{6 \times 1}^{{Y}_{2}} \\ ⋮ \\ {\vec{\sum }}_{6 \times 1}^{{Y}_{N}}\end{matrix} )}_{6 N \times 1} .$$

Therefore, based on the derivations for computing the error or noise in relative position data, the process 500 can advantageously reduce the number of samples and ground control points to determine the error. In one embodiment, the process can be implemented as described below.

In step 501, the observable ingestion module 401 determines a pair of position measurements of a point feature. As used herein, a point feature is a type of map feature that represents a place or thing that has neither length nor area at a given scale. As described above, point features are often used to show locations, such as GNSS/GPS observations (e.g., of road signs or other road objects), landmarks, events, and/or the like. In 2D, each point feature has a single pair of x,y coordinates that defines its position in the coordinate system of the feature class. In 3D, point features can also have z-coordinates (elevation) associated with them.

In one embodiment, each of the position measurements is computed from a global position measurement made using a first sensor and a relative position measurement made using a second sensor. By way of example, the first sensor (e.g., a satellite based positioning sensor such as but not limited to a GNSS/GPS receiver) used to make the global position measurement is associated with a vehicle or a device, and the second sensor is mounted to the vehicle or the device. It is noted that although the various embodiments described herein refer to an example of a car being the vehicle. Thus, the sensors of the car would be sensors making the position measurements. However, it is contemplated that the vehicle can be any type of vehicle such as but not limited to submarines equipped with sensors (e.g., sonar) that take relative position measurements, airplanes, drones, surface ships, etc. Alternatively, a mobile device can be a client terminal 115 such as but not limited to a smart phone, personal navigation device, computer, and/or equivalent. “Global position measurement”, for instance, refers to a measurement made in a global frame of reference (e.g., in ENU coordinates), and “relative position measurement” is made from the vehicle or the device to the point feature (see the discussion with respect to FIGS. 2A and 6 for additional details for global and relative position measurements).

As previously discussed, in one embodiment, the position measurements of the pair are made within a time threshold or a distance threshold. The time or distance threshold can be based on how long the error or noise of the first sensor is expected to remain constant within a designated range (e.g., a range of no more than ±5%, ±10%, ±15%, etc. change over a set time period or distance traveled). For example, a time threshold of 10 s can be set, and an equivalent distance threshold would be the time the vehicle or device can travel during the 10 s period at its current, average, predicted, etc. speed.

In one embodiment, the pair is part of plurality of pairs of the location measurements, and wherein the measurement error of the second sensor is determined based on the plurality of pairs of the location measurements. In other words, multiple pairs of two position estimates taken within a time or distance threshold can be obtained from one or more drives. The drives can all be different drives, and the distance or time between different pairs need not be within the time or distance threshold. The increased number of pairs (e.g., >20 or any other designated number) can be used to improve the accuracy of the calculated error for relative position data.

In step 503, the error module 403 determines a difference between the first position measurement and the second position measurement. In one embodiment, as discussed above, each position measurement in a pair can be denoted as the measured global position Yᵢ of point feature i. Thus, for a feature a and b, the difference between the position measurements is Yₐ−Y_{b}. This difference can be determined for each pair of measurements or drive.

In step 505, the error module 403 determines an error of the relative position measurement based on the difference. In one embodiment, the error is based on a least-squares estimate for a covariance matrix of the relative position measurement. For example, as discussed above, the error module 403 computes a first covariance matrix, Σ^{Y}, over the difference(s) computed in step 503. The error module 403 then computes a second covariance matrix, Σ^{w}, for the relative position measurement based on the first covariance matrix, Σ^{Y}. The error module 403 determines a pose of the vehicle or the device, e.g., by taking the known vehicle pose θₐ_{ₙ} and θ_{b}_{ₙ} at these observations, and compute the corresponding 3×3 matrices A_{3×3}(θₐ_{ₙ}) and A_{3×3}(θ_{b}_{ₙ}) using Equation 6. For example, the pose is determined based on an orientation of a road on which the vehicle or the device is traveling. The corresponding matrices are then used to estimate the elements of the second covariance matrix, Σ^{w}, e.g., using Equation 5 for a single pair use case, and using the pseudoinverse calculation in Equation 6 for a use case with multiple pairs. The error of the relative position measurement is based on the second covariance matrix Σ^{w}.

In step 507, the output module 405 provides the error as an output to indicate a measurement error of the second sensor used to determine the relative position measurement. In one embodiment, the output (e.g., error of the relative position measurement or error of the sensor used to make the relative position measurement) of can be used for any location-based services or application including but not limited to pre-processing data sources 103 for automated map creation and/or update processes. In other embodiments, the output can be transmitted over a communication network 113 to other components of the system 100 or other components with access to the system 100 such as but not limited to a services platform 119, services 121, content providers 123, and/or the like that can use the output of the system 100 to provide one or more functions, services, applications, etc.

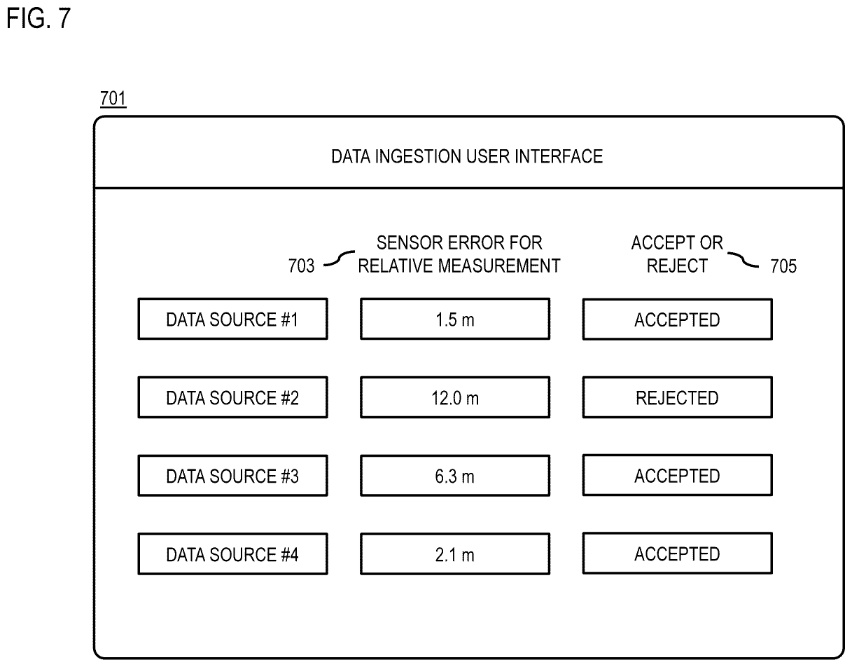

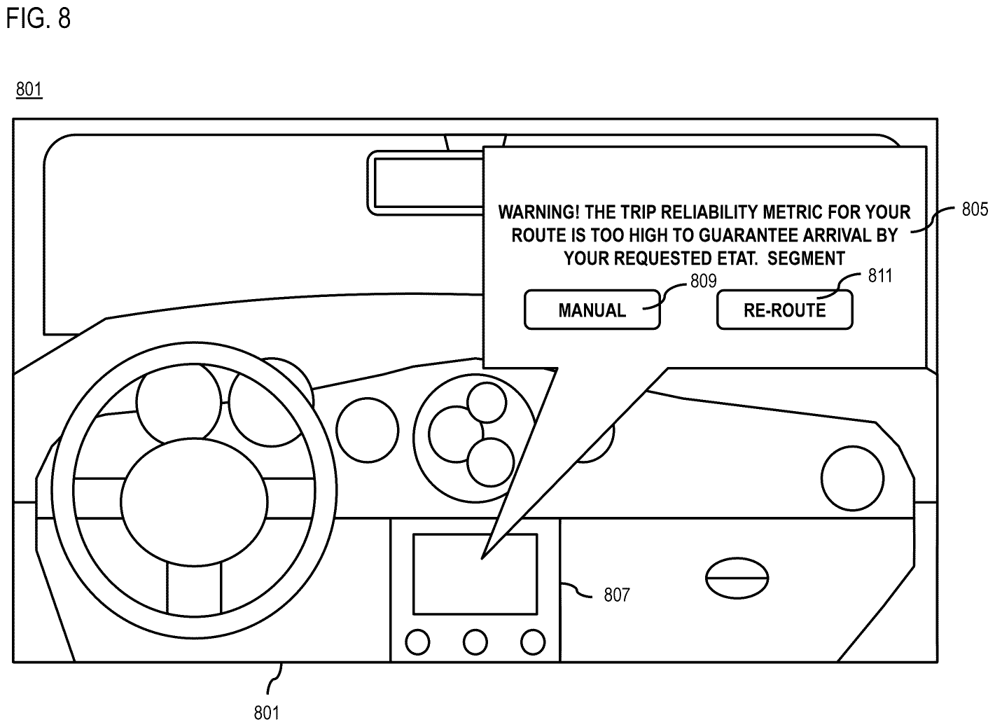

Some but not exclusive examples of uses for the output of the error of the relative position estimate are discussed below with respect to FIGS. 7 and 8.

FIG. 7 is a diagram of an example user interface (UI) 701 for evaluating data sources 103 based on measuring error in relative position data from a sensor 109, according to one example embodiment. In one, the mapping platform 101 determines whether to include a data source 103 associated with the pair of the position measurements based on the measurement error of the relative position data computed according to the various embodiments describe herein. In the example of FIG. 7, the mapping platform 101 is evaluating data sources #1-#4 for possible use in its digital map making pipeline. Each of the data sources #1-#4 include position measurements of point features that comprise at least some relative position data. The mapping platform 101 selects 20 random pairs of position measurements that meet the criterion of being sensed within a time or distance threshold.

The mapping platform 101 processes each of selected 20 pairs of position measurements to the compute the respective error in relative position data for each of the data sources #1-#4. The UI 101 displays the computed respective errors for each data source #1-#4 in UI elements 703 and provides interactive UI elements 705 to enable a user to initiate an acceptance or rejection of each data source #1-#4 for inclusion in the map making pipeline. The UI elements 705 receive user input and indicates where each data source #1-#4 is accepted or rejected. In this example, data source #2 is rejected because of its relatively high error, and all other data sources are accepted.

In one embodiment, the mapping platform 101 can also be configured to determine to include or not include the data sources #1-#4 for map making based on a purely automated process by applying an error threshold for accepting or rejecting a data source. For example, the error threshold can be specified as 8.0 m such that any a data source with an error value below this threshold is automatically accepted (e.g., data sources #1, #3, and #4) while any data source with an error equal to or greater than the threshold is automatically rejected (e.g., data source #2).

FIG. 8 is a diagram of an example user interface 801 for real-time use of measuring error in relative position data from a sensor, according to one example embodiment. In one embodiment, the mapping platform 101 can compute the error in relative position data to determine an operational status of a sensor used to make relative position measurements based on the measurement error. As used herein, the term “operational status” refers to how well the sensor is functioning. In the example of FIG. 8, a vehicle 803 is operating in autonomous mode and using its camera sensor to detect road signs for autonomous vehicle operation. As the vehicle 801 drives and collects observations of road signs, the observations (e.g., position measurements of the road signs based on the vehicle 803's position and the relative position of the sign from the vehicle) can be grouped into pairs based on whether each two measurement is within a time threshold of each other.

Once a designated number of pairs of measurements (e.g., 20 pairs or any other designated number of pairs) are gathered, the mapping platform 101 or equivalent component of the vehicle 803 can process the samples to determine the error in the relevant position data collected by the sensor of the vehicle 803. In one embodiment, the error can be computed and monitored in real-time as each batch of 20 pairs of measurements are collected. In some embodiments, each batch of pairs can be monitored a designated number of times to further identify the error or noise. If the monitoring indicates that the error in the relative position data exceeds an error threshold for autonomous operation of the vehicle 801, an alert message 805 can be presented on a display 807 to warn the driver that “Warning! Camera positioning error is too high to operate autonomously in the next road segment.” The alert message 805 also presents UI elements 809 and 811 respectively giving the driver the option for the vehicle 803 to go into manual operation mode or the re-route to another section where it may be able to continue to operate in autonomous mode.

It is noted that the above examples of using the computed error in relative position data is provided by way of illustration and not as limitations.

Returning to FIG. 1, as shown and discussed above, the system 100 includes the mapping platform 101 for measuring error in relative position data from a sensor. In one embodiment, the mapping platform 101 has connectivity or access to a one or more databases for storing the measured error in relative position data from a sensor determined according to the various embodiments described herein, and as well as a geographic database 105 for retrieving mapping data and/or related attributes. In one embodiment, the geographic database 105 can include electronic or digital representations of mapped geographic features to facilitate measuring error in relative position data. In one embodiment, the mapping platform 101 has connectivity over a communication network 113 to the services platform 119 that provides one or more services 121. By way of example, the services 121 may be third-party services that rely on location-based services created or developed to use error in relative position data generated according to the various embodiments described herein. By way of example, the services 121 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 121 uses the output of the mapping platform 101.

In one embodiment, the mapping platform 101 may be a platform with multiple interconnected components. The mapping platform 101 may include multiple servers, intelligent networking devices, computing devices, components, and corresponding software for automated detection and/or characterization of road intersections. In addition, it is noted that the mapping platform 101 may be separate entities of the system 100, a part of the one or more services 121, a part of the services platform 119, or included within the vehicles 111 and/or client terminals 115.

In one embodiment, content providers 123 may provide content or data (e.g., including geographic data, 3D models, parametric representations of mapped features, etc.) to the mapping platform 101, the services platform 119, the services 121, the client terminals 115, the vehicles 111, and/or an application 117 executing on the client terminal 115. The content provided may be any type of content, such as sensor data, map content, textual content, audio content, video content, image content, etc. used for detecting and/or characterizing road intersections. In one embodiment, the content providers 123 may also store content associated with the mapping platform 101, geographic database 105, services platform 119, services 121, client terminal 115, and/or vehicle 111. In another embodiment, the content providers 123 may manage access to a central repository of data, and offer a consistent, standard interface to data, such as a repository of the geographic database 105.

In one embodiment, the client terminal 115 and/or vehicle 111 may execute a software application 117 to capture sensor or other observation data (e.g., observables with relative position data) for processing by mapping platform 101 according to the embodiments described herein. By way of example, the application 117 may also be any type of application that is executable on the client terminal 115 and/or vehicle 111, such as autonomous driving applications, mapping applications, location-based service applications, navigation applications, content provisioning services, camera/imaging application, media player applications, social networking applications, calendar applications, and the like. In one embodiment, the application 117 may act as a client for the mapping platform 101 and perform one or more functions associated with automated detection and/or characterization of road intersections alone or in combination with the mapping platform 101.

By way of example, the client terminal 115 is any type of computer system, embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the client terminal 115 can support any type of interface to the user (such as “wearable” circuitry, etc.). In one embodiment, the client terminal 115 may be associated with the vehicle 111 or be a component part of the vehicle 111.

In one optional embodiment, the client terminal 115 and/or vehicle 111 are configured with various sensors for generating or collecting sensor observations (e.g., for processing mapping platform 101), related geographic data, etc. In one embodiment, the sensed data represents sensor data associated with a geographic location or coordinates at which the sensor data was collected to detect point features (e.g., road objects, road signs, landmarks, etc.). In this way, the sensor data can act as observation data that can be processed to determine error in relative position data according to the various embodiments described herein. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, radar, an audio recorder for gathering audio data, velocity sensors mounted on steering wheels of the vehicles, switch sensors for determining whether one or more vehicle switches are engaged, and the like.

Other examples of optional sensors of the client terminal 115 and/or vehicle 111 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the client terminal 115 and/or vehicle 111 may detect the relative distance of the vehicle to a road boundary, the presence of other vehicles, pedestrians, traffic lights, potholes and any other objects, or a combination thereof. In one scenario, the sensors may detect weather data, traffic information, or a combination thereof. In one embodiment, the client terminal 115 and/or vehicle 111 may include GPS or other satellite-based receivers to obtain geographic coordinates or signal for determine the coordinates from satellites. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In another optional embodiment, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 101, services platform 119, services 121, client terminal 115, vehicle 111, and/or content providers 123 optionally communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

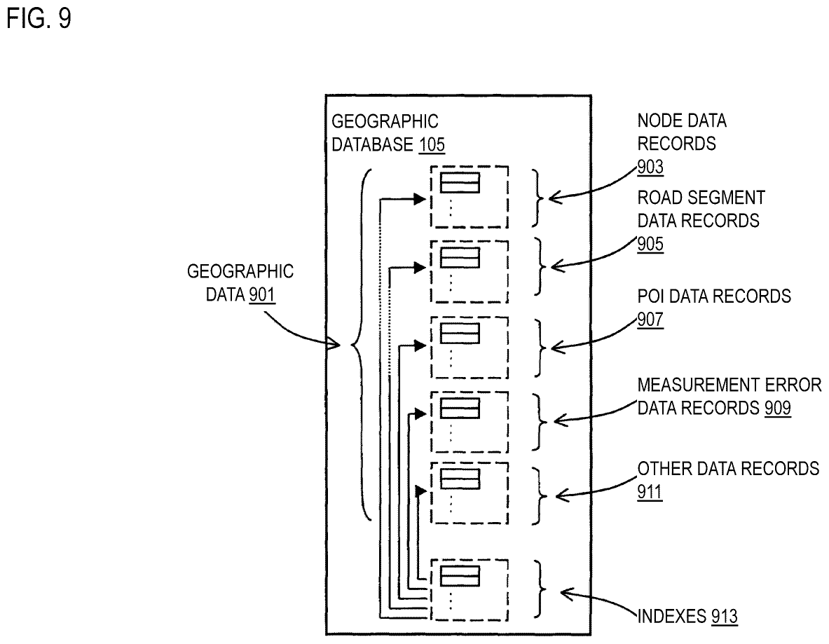

FIG. 9 is a diagram of the geographic database 105, according to one embodiment. In one embodiment, the geographic database 105 includes geographic data 901 used for (or configured to be compiled to be used for) mapping and/or navigation-related services, such as for video odometry based on the parametric representation of signs include, e.g., encoding and/or decoding parametric representations into object models of signs. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 105.

“Node”—A point that terminates a link.

“Line segment”—A straight line connecting two points.

“Link” (or “edge”)—A contiguous, non-branching string of one or more line segments

terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 903, road segment or link data records 905, POI data records 907, measurement error data records 909, other records 911, and indexes 913, for example. More, fewer, or different data records can be provided. In one embodiment, additional data records (not shown) can include cartographic (“carto”) data records, routing data, and maneuver data. In one embodiment, the indexes 913 may improve the speed of data retrieval operations in the geographic database 105. In one embodiment, the indexes 913 may be used to quickly locate data without having to search every row in the geographic database 105 every time it is accessed. For example, in one embodiment, the indexes 913 can be a spatial index of the polygon points associated with stored feature polygons.

In exemplary embodiments, the road segment data records 905 are links or segments representing roads, streets, or paths, as can be used in the calculated route or recorded route information for determination of one or more personalized routes. The node data records 903 are end points (such as intersections) corresponding to the respective links or segments of the road segment data records 905. The road link data records 905 and the node data records 903 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 907. The geographic database 105 can also include data about places, such as cities, towns, or other communities, and other geographic features, such as bodies of water, mountain ranges, etc. Such place or feature data can be part of the POI data records 907 or can be associated with POIs or POI data records 907 (such as a data point used for displaying or representing a position of a city).

In one embodiment, the geographic database 105 can also include measurement error data records 909 for storing computed error in relative position data, pairs of position measurements, and or any related data generated or used according to the various embodiments described herein. In one embodiment, the measurement error data records 909 can be associated with one or more of the node records 903, road segment records 905, and/or POI data records 907 to associate the detected and/or characterized intersections with specific geographic locations. In this way, the detected and/or characterized intersections can also be associated with the characteristics or metadata of the corresponding record 903, 905, and/or 907.

In one embodiment, the geographic database 105 can be maintained by the content provider 123 in association with the services platform 119 (e.g., a map developer). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle (e.g., vehicle 111 and/or client terminal 115) along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 111 or client terminal 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for measuring error in relative position data from a sensor may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

FIG. 10 illustrates a computer system 1000 upon which an embodiment of the invention may be implemented. Computer system 1000 is programmed (e.g., via computer program code or instructions) to measure error in relative position data from a sensor as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to measuring error in relative position data from a sensor. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for measuring error in relative position data from a sensor. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk, or flash card, for storing information, including instructions, that persists even when the computer system 1000 is turned off or otherwise loses power.

Information, including instructions for measuring error in relative position data from a sensor, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners, and external disks. In general, the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic, or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 113 for measuring error in relative position data from a sensor.

The term computer-readable medium is used herein to refer to any medium that participates in providing information to processor 1002, including instructions for execution. Such a medium may take many forms, including, but not limited to, non-volatile media, volatile media, and transmission media. Non-volatile media include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system can be deployed in various configurations within other computer systems, e.g., host 1082 and server 1092.

FIG. 11 illustrates a chip set 1100 upon which an embodiment of the invention may be implemented. Chip set 1100 is programmed to measure error in relative position data from a sensor as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to measure error in relative position data from a sensor. The memory 1105 also stores the data associated with or generated by the execution of the inventive steps.

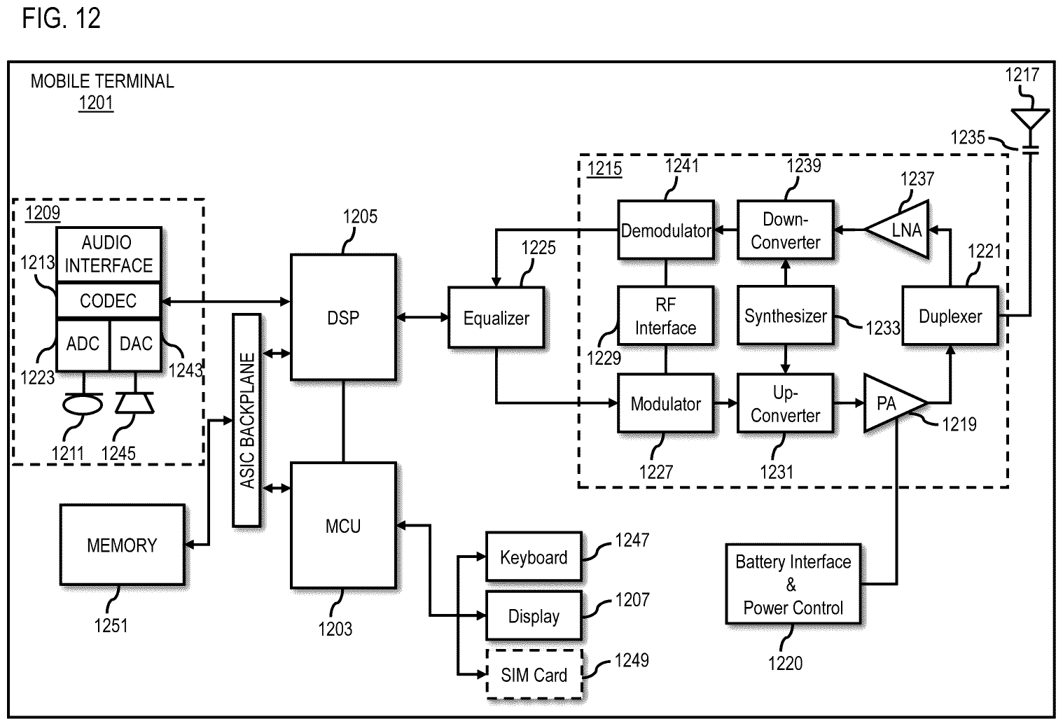

FIG. 12 is a diagram of exemplary components of a mobile terminal 1201 (e.g., handset or vehicle or parts thereof) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions that offer automatic contact matching. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile station 1201 to measure error in relative position data from a sensor. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1251 may be, but not limited to, a single memory, CD, DVD, ROM, RAM, EEPROM, optical storage, or any other non-volatile or non-transitory storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
determining, by a processor, a pair of position measurements of a point feature, wherein each of the position measurements is computed from a global position measurement made using a first sensor and a relative position measurement made using a second sensor, and wherein the position measurements of the pair are made within a time threshold or a distance threshold;
determining, by the processor, a difference between the first position measurement and the second position measurement;
determining, by the processor, an error of the relative position measurement based on the difference; and
providing, by the processor, the error as an output to indicate a measurement error of the second sensor used to determine the relative position measurement.

2. The method of claim 1, wherein the error is based on a least-squares estimate for a covariance matrix of the relative position measurement.

3. The method of claim 1, further comprising:
computing a first covariance matrix over the difference;
estimating a second covariance matrix for the relative position measurement based on the first covariance matrix,
wherein the error of the relative position measurement is based on the second covariance matrix.

4. The method of claim 1, wherein the pair is part of plurality of pairs of the location measurements, and wherein the measurement error of the second sensor is determined based on the plurality of pairs of the location measurements.

5. The method of claim 1, wherein the distance threshold is based on a distance over which another measurement error associated with the first sensor remains constant within a threshold range.

6. The method of claim 1, wherein the first sensor used to make the global position measurement is associated with a vehicle or a device, and wherein the second sensor is mounted to the vehicle or the device.

7. The method of claim 6, further comprising:
determining a pose of the vehicle or the device,
wherein the error of the relative position measurement is further based on the pose of the vehicle or the device.

8. The method of claim 7, wherein the pose is determined based on an orientation of a road on which the vehicle or the device is traveling.

9. The method of claim 6, wherein the relative position measurement is made from the vehicle or the device to the point feature.

10. The method of claim 1, wherein the first sensor is a satellite-based positioning sensor.

11. The method of claim 1, further comprising:
determining to include a data source associated with the pair of the position measurements based on the measurement error.

12. The method of claim 1, further comprising:
determining an operational status of the second sensor based on the measurement error.

13. An apparatus comprising:
at least one processor; and
at least one memory including computer program code for one or more programs, the at least one memory and the computer program code configured to, with the at least one processor, cause the apparatus to perform at least the following,
determine a pair of position measurements, wherein each of the position measurements is computed from a global position measurement of a vehicle or a device and a relative position measurement from the vehicle or the device, and wherein the position measurements of the pair are made within a time threshold or a distance threshold;
determine a difference between the first position measurement and the second position measurement;
determine an error of the relative position measurement based on the difference; and
providing the error as an output.

14. The apparatus of claim 13, wherein the global position measurement is made using a first sensor with a measurement error that is constant within a threshold range over the distance threshold.

15. The apparatus of claim 13, wherein the relative position measurement is made using a second sensor with a normally distributed measurement error.

16. The apparatus of claim 13, wherein the position measurements and the global position measurement is made with respect to a global frame of reference, and wherein the relative position measurement is made with respect to a local frame of reference of the vehicle or the device.

17. The apparatus of claim 13, wherein the error is further based on an orientation of the vehicle or the device.

18. A non-transitory computer-readable storage medium, carrying one or more sequences of one or more instructions which, when executed by one or more processors, cause an apparatus to perform:
determining a pair of position measurements of a point feature, wherein each of the position measurements is computed from a global position measurement made using a first sensor and a relative position measurement made using a second sensor, and wherein the position measurements of the pair are made within a time threshold or a distance threshold;
determining a difference between the first position measurement and the second position measurement;
determining an error of the relative position measurement based on the difference; and
providing the error as an output to indicate a measurement error of the second sensor used to determine the relative position measurement.

19. The non-transitory computer-readable storage medium of claim 18, wherein the pair is part of plurality of pairs of the location measurements, and wherein the measurement error of the second sensor is determined based on the plurality of pairs of the location measurements.

20. The non-transitory computer-readable storage medium of claim 17, wherein the measurement error is based on a least-squares estimate for a covariance matrix of the relative position measurement.
